(19) United States
(12) Patent Application Publication
(10) Pub. No.: US 2018/0225623 A1
(43) Pub. Date: Aug. 9, 2018

(54) SYSTEM AND METHOD FOR IMPROVED INVENTORY MANAGEMENT OF RETURNED RETAIL ITEMS

(71) Applicant: Wal-Mart Stores, Inc., Bentonville, AR (US)

(72) Inventors: Theresa Mosier, Springdale, AR (US); Tina Kurtz, Rogers, AR (US)

(73) Assignee: Wal-Mart Stores, Inc., Bentonville, AR (US)

(21) Appl. No.: 15/882,523

(22) Filed: Jan. 29, 2018

Related U.S. Application Data
(60) Provisional application No. 62/456,962, filed on Feb. 9, 2017.

(51) Int. Cl. G06Q 10/08; G06F 17/30

(52) U.S. Cl. CPC G06Q 10/087; G06F 17/30377

(57) ABSTRACT

Systems, methods, and computer-readable storage media for improved inventory management of returned merchandise. Returned items are labeled using a smart label, which allows for easy tracking of the physical location of the returned items, as well as the reasons for the product being returned. When the items are scanned using the smart labels, updates to the store inventory and the global product inventory can occur, thereby allowing the returned item to be used in both local and online sales.

### BACKGROUND

### 1. Technical Field

The present disclosure relates to improved inventory management and more specifically to improvements in updating store and global inventory databases as items are returned to a store.

### 2. Introduction

Traditionally, when customers return merchandise to a store, store associates must determine whether to reinsert the merchandise into the store's inventory system for resale or to discard the item. However, the systems to record where in the store the product is, the condition of the product, and whether the product needs to be disposed of, often result in inventory problems such as overstocking, incorrect accounting of products, lost products, or excessive accumulation of non-sellable inventory. With increased integration of in-store inventory via online sales these problems have become more pronounced, as the products customers thought they could buy online may not be in a condition for resale, or may not be locatable within the store.

### SUMMARY

Disclosed herein are systems, methods, and computer-readable storage mediums for improved inventory management of returned retail items. An exemplary method for performing improved inventory management can include receiving, at a server, a notification that an item is being returned to a store; providing, to an electronic device in response to the notification, a returned item identification which is incorporated into a smart label, wherein the returned item identification comprises an item type of the item and a reason code for the item being returned; receiving, at the server, a first communication indicating the item has been received at the store with the smart label affixed to the item; receiving, at the server, a second communication indicating a physical location of the item within the store; determining, based on the reason code, to add the item to an inventory system, to yield a determination, the inventory system comprising a store-specific product inventory database and a global product inventory database; updating the store-specific product inventory database based on the determination, the first communication, and the second communication, the store-specific product inventory database being associated with the store; and updating the global product inventory database based on the determination, the first communication, and the second communication.

A system for providing improved inventory management can include a processor and a computer-readable storage medium having instructions stored which, when executed by the processor, cause the processor to perform operations including receiving a notification that an item is being returned to a store, wherein the notification is generated by a mobile device of a customer; providing, to an electronic device in response to the notification, a returned item identification which is incorporated into a smart label, wherein the returned item identification comprises an item type of the item and a reason code for the item being returned; receiving a first communication indicating the item has been received at the store with the smart label affixed to the item; receiving a second communication indicating a physical location of the item within the store; determining, based on the reason code, to add the item to an inventory system, to yield a determination, the inventory system comprising a store-specific product inventory database and a global product inventory database, wherein the store-specific product inventory database reflects inventory of the store for at least the item type and the global product inventory reflects worldwide inventory of at least the item type; updating the store-specific product inventory database based on the determination, the first communication, and the second communication, the store-specific product inventory database being associated with the store; and updating the global product inventory database based on the determination, the first communication, and the second communication.

A non-transitory computer-readable storage medium for providing improved inventory management can have instructions stored which, when executed by a computing device, cause the computing device to perform operations including receiving, at a server, a notification that an item is being returned to a store; providing, to an electronic device in response to the notification, a returned item identification which is incorporated into a smart label, wherein the returned item identification comprises an item type of the item and a reason code for the item being returned; receiving, at the server, a first communication indicating the item has been received at the store with the smart label affixed to the item; receiving, at the server, a second communication indicating a physical location of the item within the store; determining, based on the reason code, to add the item to an inventory system, to yield a determination, the inventory system comprising a store-specific product inventory database and a global product inventory database; updating the store-specific product inventory database based on the determination, the first communication, and the second communication, the store-specific product inventory database being associated with the store; and updating the global product inventory database based on the determination, the first communication, and the second communication.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example flow of returned products to merchandise locations;

FIG. 2 illustrates an exemplary a smart label system for inventory management;

FIG. 3 illustrates an exemplary method embodiment; and

FIG. 4 illustrates an example computer system which can be used to perform inventory management operations.

### DETAILED DESCRIPTION

Traditional merchandise return services require the customer to return products back to the same physical store where the products were purchased, while more advanced merchandise return services (such as for store chains having multiple locations) allow customers to return the products to any physical location of the store chain. With the rise of online shopping, customers also have the ability to return products purchased online via mail services.

Inventory management systems configured as described herein utilize smart labels to track the location of the returned item throughout the store where the item was returned, while also updating both the store's inventory and a global product inventory. This can be applied to merchandise which was purchased online or in a physical store, and can likewise be applied to returns which occur via mail services or in the store. In addition, because of the improvements to the inventory system, both in-store customers and online customers can view improved inventory estimates, and store employees can have detailed information regarding the precise location of the returned item within the store.

If, for example, the customer returns the purchased item to a physical store, a customer service representative can help the customer by verifying the receipt (whether a physical version or, if purchased online, a digital version), then affixing a smart label to the returned item. More specifically, the representative can perform a barcode scan (or otherwise enter the item type into a computer system) and can enter a reason code for why the product is being returned. The computer system may then generate a returned item identification (such as a number or code) which identifies the returned item. The returned item identification, the type of the item, and/or the reason code for the product being returned can then be incorporated into a smart label which is printed by the representative's register or other computing device.

In other circumstances, the customer can initiate the return process at home on a computer or on their mobile device. The customer can, for example, use their mobile phone to take a picture of the item being returned along with the receipt, then upload the information to the store computing system using a store-specific computer program/app, which allows the system to generate the return item identification and generate the smart label. In some configurations, the customer can print the smart label using their own printer, which can allow the customer to return the product to the vendor using mail services. In other configurations, the customer uses online or mobile applications to initiate the return process, brings the item into a physical store and uses a kiosk to print the smart label, and then presents the item with the smart label to a customer service representative. In yet other configurations, the user presents the item to the customer service representative having generated the return item identification online, but not having printed the smart label, at which point the customer service representative can look up the return item identification in the store's computer system and print the smart label.

Regardless of how the product is returned to the vendor, when the smart label is affixed to the product, at some point the vendor's customer service representative will have the returned product in-hand, and be able to verify the reason code being presented by the customer. At this point, the customer service representative can “scan” the item into the vendor's system by using a scanner (such as a bar-code reader, QR code reader, RF code reader, or other item scanner). The customer service representative can also scan a label associated with the bin where the item will be stored. This bin, the physical location where the returned item is stored, allows the vendor's system to know, with precision, where the returned item is located.

Having scanned the returned item's smart label, the system can determine, based on the reason code, if the item should be returned to the vendor's inventory system for resale or if the item should be disposed of. This determination can also take into account additional codes, such as seasonal codes for seasonal items, store-specific codes (i.e., urban versus rural items), perishable items, etc. If the item is to be disposed, the item can enter a claims process, whereby the item can be destroyed, sold for a large discount, or otherwise disposed of. If the item is to be resold, the item is added to the vendor's inventory system, and specifically added to both the store-specific inventory of the store where the item is located and the global product inventory of the vendor across multiple stores. The store-specific inventory can, for example, provide store associates with up-to-date inventory quantities and locations, and can also be used to provide online customers information regarding the number of stocked items for that product type at a specific store. The global product inventory, by contrast, can be used to notify online customers of the world-wide number of items available. The global product inventory can also, for example, be used to fill online orders, to provide estimates on delivery times, and/or regional availability.

Such systems allow for improved inventory control within a store, and also allow for a greater connection between in-store and online sales. For example, a product may be returned and an in-store associate can identify precisely where the returned product is located. In such a case, if a customer were to ask a store associate if there are additional items of that item type available, the store associate can choose to see (1) the number of items available on the shelf; (2) the number of items, if any, in the back storage area; and/or (3) the number of returned products and their respective locations. As another example, a customer looking at the vendor online can see an availability of the item type online, as well as the number of those items at particular stores.

These examples and other will be further described as the illustrations of the disclosure are described in detail below. While specific implementations are described, it should be understood that this is done for illustration purposes only. Other components and configurations may be used without parting from the spirit and scope of the disclosure. In addition, components, steps, and features described may be removed, added, or combined from the provided examples.

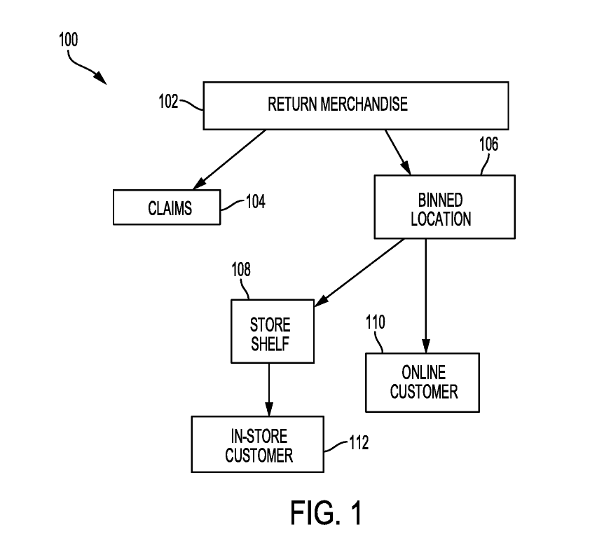

FIG. 1 illustrates an example flow 100 of returned products to merchandise locations. First, the merchandise is returned 102 and the system determines, based on the reason code (and/or other codes), if the returned item should be disposed of or processed for resale. In one configuration, items being disposed of via a claims process 104 are not entered into the inventory system of the vendor, whereas in other configurations items in the claims process 104 are entered in the inventory system until the product is removed or otherwise disposed of.

Items which are identified as being processed for resale are placed in a binned location 106. For example, the binned location 106 can be a temporary location in a customer service area set aside for returned products, or other location within the store specific to returned products to be held prior to re-shelving the items. Such areas can, for example, be used to centralize products needing inspection before being returned to store shelves. Once any required inspections have occurred, the item can be sold online 110 or can be restocked on a store shelf 108, with the store shelf 108 replacing the original bin location. At that point, the item will eventually be purchased by an in-store customer 112 and removed from inventory.

It is noted that in other configurations, the concepts illustrated in FIG. 1 may be arranged distinctly. For example, despite items being in the claims process 104, some configurations may still offer online sales of the returned product to online customers 110, or discounted sales to in-store customers 112. In such configurations, the returned item can be included in the inventory system with distinct reason codes or inventory classifications.

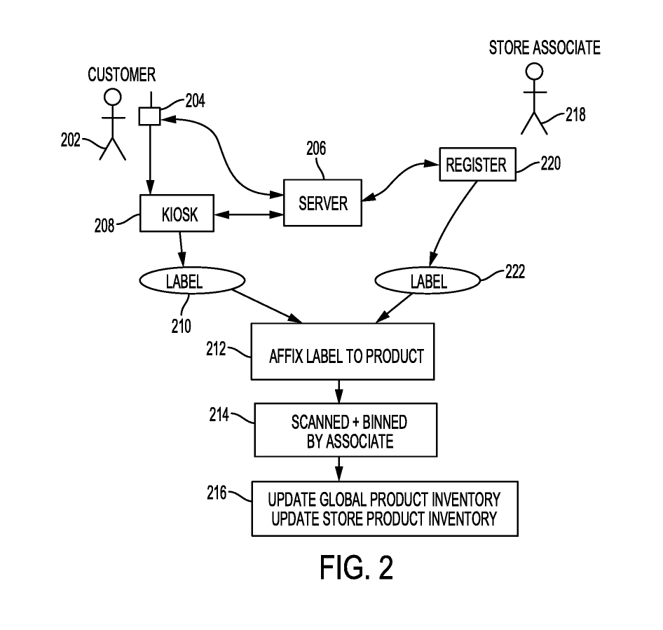

FIG. 2 illustrates an exemplary a smart label system for inventory management, and shows how the disclosed inventory management concepts disclosed herein can be applied to both a customer 202 initiated return process and a store associate 218 initiated return process. Beginning with the customer 202 initiated return process, the customer 202 initiates the return process using an electronic device 204, through which a server 206 associated with the vendor is contacted. Exemplary electronic devices include smartphones, tablets, computers, laptops, mobile phones, smart wearables (such as smart watches), etc. The customer 202 indicates, through the electronic device 204, that the customer 202 has a product to return. In some configurations, this could require the customer 202 to provide a current picture of the product, a picture of the receipt, enter the receipt number, enter the price paid for the item, provide an online order number, provide a shipping number, etc.

With the received information, the server 206 can generate a return item identification for the product. The customer 202 can then take the product to a physical store and, using a kiosk 208, print the smart label 210 for the item. The kiosk 208 and the server 206 have communicated the return item identification such that when the customer 202 arrives and presents identification (such as a credit card, driver license, etc.), the kiosk 208 is prepared to print the smart label 210. In other configurations, where the customer 202 is able to print the smart label for return via mail services, the return item identification can be communicated from the server 206 to the customer's electronic device 204, from which the smart label may be printed (or instructions to print the smart label may be given).

When the customer 202 takes the product to be returned, without the smart label already affixed or having done other pre-return processing, to the customer service desk at the store, a store associate 218 may assist the customer 202 with the return in a “normal” return manner. In this scenario, the store associate 218 may use a register 220 or other computing device to record that the item is being returned and a reason why the product is being returned. However, unlike standard return practices, at that point the register 220 may communicate with the central server 206, and the server 206 may generate the return item identification. The return item identification information may then be communicated back from the server 206 to the register 220, and the register 220 can print the smart label 222.

Once the smart label 210, 222 is printed, it is affixed to the product 212, at which point a store associate scans the product as ‘received’ and places the returned product in a bin 214. The system then updates the global product inventory and the store product inventory 216 to reflect the additional, returned product.

In circumstances where the product is returned to a receiving/distribution center via a mailing service with the smart label affixed, the customer 202 has already affixed the label to the product 212, and the associate at the receiving/distribution center can follow the same scanning and binning processes 214 in-store associates would follow. Likewise, the process of updating the global inventory would remain constant, while the store product inventory would change to a product inventory for the receiving/distribution center.

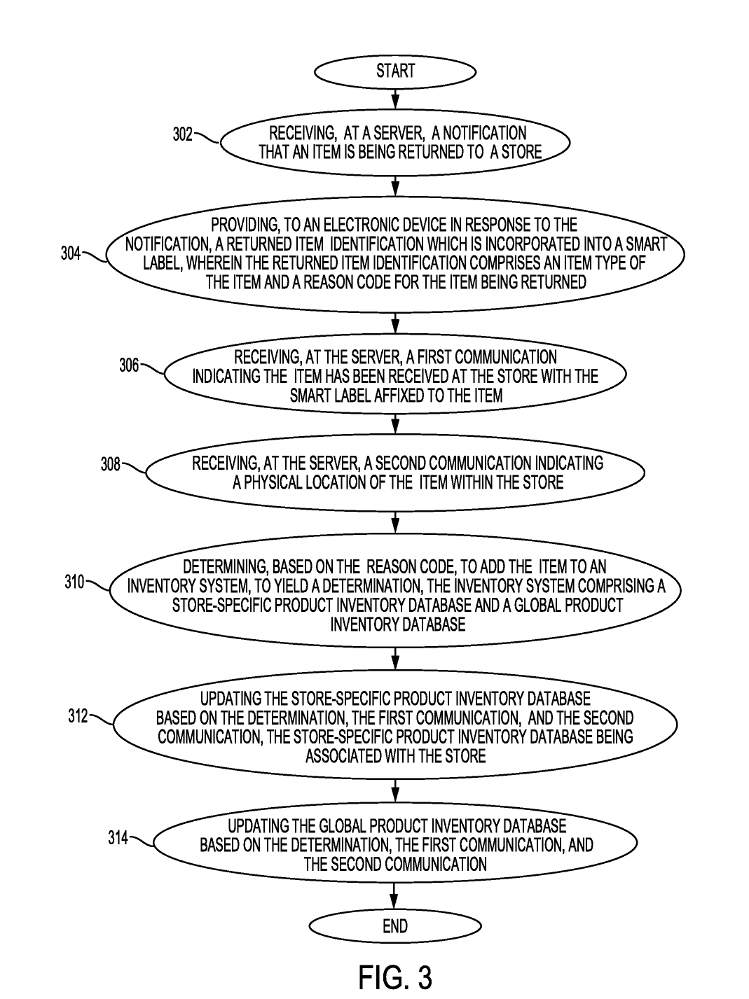

FIG. 3 illustrates an exemplary method embodiment which can be performed, for example, by the server 206 of FIG. 2. The steps outlined herein are exemplary and can be implemented in any combination thereof, including combinations that exclude, add, or modify certain steps.

The server 206 receives 302 a notification that an item is being returned to a store (302). The notification can, for example, be generated by a mobile device of a customer, or can be generated by a store register being operated by a store associate. The server 206 provides, to an electronic device in response to the notification, a returned item identification which is incorporated into a smart label, wherein the returned item identification comprises an item type of the item and a reason code for the item being returned (304). Exemplary reason codes are that the item didn't work, that the customer just didn't need the product, that the product was not as advertised, etc. The reason code can also include determinations by the store associate, such that the customer was a smoker and the product now smells of smoke, that the product was a food product and is now expired, or that the reasons provided by the customer are questionable.

The server 206 receives a first communication indicating the item has been received at the store with the smart label affixed to the item (306) and also receives a second communication indicating a physical location of the item within the store (308). This physical location of the item can, for example, represent that the item is to be removed from the inventory system, such as in a claims process, whereas in other examples the physical location is for a bin to temporarily store returned items. In one example, the store associate uses a bar code scanner to scan the returned product's smart label, telling the system that an action is about to take place with the returned product. The store associate then scans the bin where the returned item is placed, telling the system that the physical location of the returned product is that bin.

Based on the reason code, the server 206 determines to add the item to an inventory system, to yield a determination, the inventory system comprising a store-specific product inventory database and a global product inventory database (310). If, for example, the reason code indicates that the product is ready for immediate return to the shelves, the inventory system can be updated. If the reason code indicates that the product needs to be physically reviewed by a store associate before determining further action, the product may be kept in a specialized area until the review occurs. In yet other instances, the reason code may indicate that the product will not be returned to the store shelves, in which case the product may enter the claims process for removal from the store.

The server 206 updates, or causes to be updated, the store-specific product inventory database based on the determination, the first communication, and the second communication, the store-specific product inventory database being associated with the store (312). The server 206 also updates, or causes to be updated, the global product inventory database based on the determination, the first communication, and the second communication (314). The global product inventory can, for example, reflect worldwide inventory of at least the item type.

The reason code can indicate the item fails to meet a standard for returning the item to normal sale status, or that the store associate thinks it should be disposed of. In addition, the reason code, as described herein, can also include seasonal codes (i.e., Halloween items versus Christmas items), regional items, etc. For example, updating the inventory system can depend on other factors, such as the season code (i.e., Christmas items returned in February might be discarded), quality codes, regional codes (i.e., camouflage purchased in rural areas might not be sold in particular urban stores). These codes can be part of the reason code, or can be recorded separately. The server 206 can review such codes in determining if the item should be added to the store-specific and/or global inventories.

In other instances, the method can be further expanded to include, for example, receiving, at the server 206, an online request for the item type; and returning, in response to the online request, an availability of the item type based on an updated global product inventory database.

In addition, the method can, in certain configurations, include receiving, at the server 206, an online request for the item type; identifying the item as satisfying the online request; and issuing a notification for a store associate to fill the online request by retrieving the item from the physical location.

Yet another configuration can include receiving, at the server 206, a request from a store associate in the store for locations of the item type within the store; and issuing a notification to the store associate, the notification comprising the physical location of the item. For example, the request from the store associate may be a request for a quantity of the item type within the store, wherein the notification to the store associate includes the quantity of the item type within the store based on an updated store-specific product inventory database.

The analysis performed to determine if the returned item should be disposed of or reintroduced into the inventory system can employ a rules engine, where the rules engine obtains realtime inventory of the inventory system (both local and global databases), and uses the realtime inventory with the reason code to determine if the item should be returned to inventory. In one example, the rules engine can make decisions in a binary fashion by receiving data for the realtime inventory of local stores, of a local distribution center, and/or the global inventory, then answering yes/no as to being restocked on a local and/or global level based on that realtime data in conjunction with the reason code. In another example, the rules engine can make non-binary determinations, employing “if-then-else” logic, or otherwise making decisions based on inventory quantities, quality codes (e.g., good, fair, like-new) made by store associates, seasonal need, etc.

Consider the following example. A consumer returns Christmas wrapping paper in July. The rules engine can use a realtime logic process to make the determination if the wrapping paper should be put back into inventory. The store associate scans the item, and the server performing the rules engine analysis: (1) receives current store inventory—Is this item currently in the store? Is there a dedicated space within the store (either on the shelves or in back-storage areas) for the item?; (2) receives inventory for the nearest distribution center near the store where the item was returned—Is the item in stock in the distribution center? Is there a dedicated space within the distribution center where the item could be located? What is the cost of moving the item to the distribution center?; (3) receives disposal costs associated with the item—What is the cost of disposing of the item?; (4) receives global inventory for the item—Is this in-stock elsewhere? If so, what is the cost of moving the item to that location? What are the online sales of this item? What is the expected profit for this item if it is inventoried in the store until an online sale takes place? What is the expected profit for this item if it is inventoried in the distribution center until an online sale takes place?; (5) receives seasonal codes—Is this a seasonal item? If so, should it be immediately placed on a shelf? If not, should it be weighted higher or lower for return to inventory? All of this data is put into a data matrix, and the rules/questions are applied. Application of the rules can be done serially, in parallel, or in a weighted fashion (where answers to particular questions/rules weigh the likelihood of returning the product to inventory one way or the other). Based on the rules engine analysis, a determination is made whether the product should be re-introduced to the inventory system, and if so, where and how it should be re-introduced.

Because the analysis, and by extension the rules engine, is performed by a processor using real-time data, the store associate scanning the item is automatically told by the system where the product should be binned and for what purpose (disposal or re-introduction to the inventory system). This can improve the speed of the return system, but more critically can improve the quality of returns because the human element of decision making is removed, because the exact location of the returned item is known, and because the item, if being placed back into inventory, is automatically placed into the global inventory database. The integration of locally returned items into the global inventory system can aid online sales and can improve profitability, all while increasing the speed of the transactions.

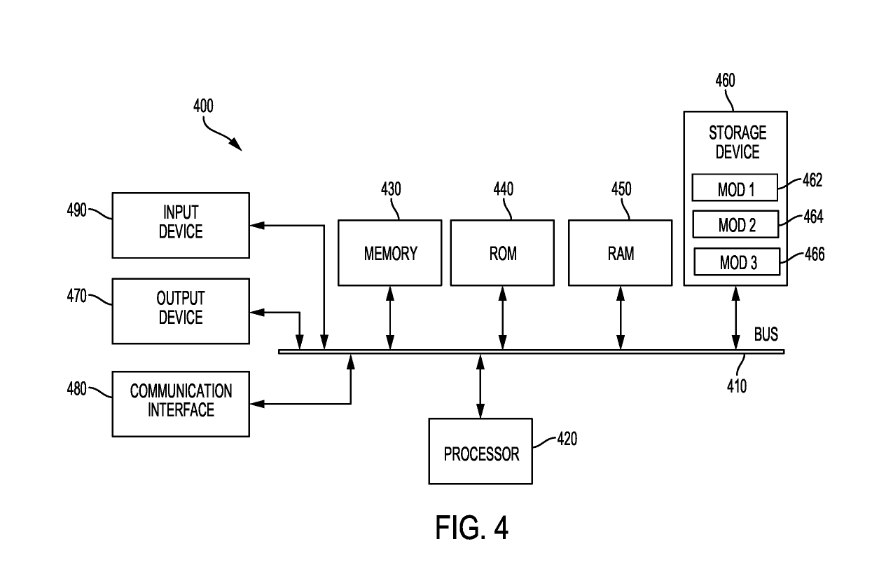

FIG. 4 illustrates an example computer system which can be used to perform inventory management operations as disclosed herein. More specifically, FIG. 4 illustrates a general-purpose computing device 400, including a processing unit (CPU or processor) 420 and a system bus 410 that couples various system components including the system memory 430 such as read only memory (ROM) 440 and random access memory (RAM) 450 to the processor 420. The system 400 can include a cache 422 of high speed memory connected directly with, in close proximity to, or integrated as part of the processor 420. The system 400 copies data from the memory 430 and/or the storage device 460 to the cache 422 for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 4 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a server, a notification that an item is being returned to a store;
providing, to an electronic device in response to the notification, a returned item identification which is incorporated into a smart label, wherein the returned item identification comprises an item type of the item and a reason code for the item being returned;
receiving, at the server, a first communication indicating the item has been received at the store with the smart label affixed to the item;
receiving, at the server, a second communication indicating a physical location of the item within the store;
determining, based on the reason code, to add the item to an inventory system, to yield a determination, the inventory system comprising a store-specific product inventory database and a global product inventory database;
updating the store-specific product inventory database based on the determination, the first communication, and the second communication, the store-specific product inventory database being associated with the store; and
updating the global product inventory database based on the determination, the first communication, and the second communication.

2. The method of claim 1, further comprising:
receiving, at the server, an online request for the item type; and
returning, in response to the online request, an availability of the item type based on an updated global product inventory database.

3. The method of claim 1, further comprising:
receiving, at the server, an online request for the item type;
identifying the item as satisfying the online request; and
issuing a notification for a store associate to fill the online request by retrieving the item from the physical location.

4. The method of claim 1, further comprising:
receiving, at the server, a request from a store associate in the store for locations of the item type within the store; and
issuing a notification to the store associate, the notification comprising the physical location of the item.

5. The method of claim 4, wherein the request from the store associate further requests a quantity of the item type within the store; and
wherein the notification to the store associate further comprises the quantity of the item type within the store based on an updated store-specific product inventory database.

6. The method of claim 1, wherein the global product inventory reflects worldwide inventory of at least the item type.

7. The method of claim 1, wherein the reason code indicates the item fails to meet a standard for returning the item to normal sale status; and
the physical location of the item represents that the item is to be removed from the inventory system.

8. The method of claim 1, wherein the notification is generated by a mobile device of a customer.

9. A system comprising:
a processor; and
a computer-readable storage medium having instructions stored which, when executed by the processor, cause the processor to perform operations comprising:
receiving a notification that an item is being returned to a store, wherein the notification is generated by a mobile device of a customer;
providing, to an electronic device in response to the notification, a returned item identification which is incorporated into a smart label, wherein the returned item identification comprises an item type of the item and a reason code for the item being returned;
receiving a first communication indicating the item has been received at the store with the smart label affixed to the item;
receiving a second communication indicating a physical location of the item within the store;
determining, via a rules engine, to add the item to an inventory system, to yield a determination, wherein the rules engine obtains realtime inventory of an inventory system, the inventory system comprising a store-specific product inventory database and a global product inventory database, and uses the realtime inventory with the reason code to ensure that adding the item to the inventory system passes a plurality of inventory rules;
updating the store-specific product inventory database based on the determination, the first communication, and the second communication, the store-specific product inventory database being associated with the store; and
updating the global product inventory database based on the determination, the first communication, and the second communication.

10. The system of claim 9, the computer-readable storage medium having additional instructions stored which, when executed by the processor, cause the processor to perform operations comprising:
receiving, at the server, an online request for the item type; and
returning, in response to the online request, an availability of the item type based on an updated global product inventory database.

11. The system of claim 9, the computer-readable storage medium having additional instructions stored which, when executed by the processor, cause the processor to perform operations comprising:
receiving, at the server, an online request for the item type;
identifying the item as satisfying the online request; and
issuing a notification for a store associate to fill the online request by retrieving the item from the physical location.

12. The system of claim 9, the computer-readable storage medium having additional instructions stored which, when executed by the processor, cause the processor to perform operations comprising:
receiving, at the server, a request from a store associate in the store for locations of the item type within the store; and
issuing a notification to the store associate, the notification comprising the physical location of the item.

13. The system of claim 12, wherein the request from the store associate further requests a quantity of the item type within the store; and
wherein the notification to the store associate further comprises the quantity of the item type within the store based on an updated store-specific product inventory database.

14. The system of claim 9, wherein the reason code indicates the item fails to meet a standard for returning the item to normal sale status; and
the physical location of the item represents that the item is to be removed from the inventory system.

15. A non-transitory computer-readable storage medium having instructions stored which, when executed by a computing device, cause the computing device to perform operations comprising:
receiving, at a server, a notification that an item is being returned to a store;
providing, to an electronic device in response to the notification, a returned item identification which is incorporated into a smart label, wherein the returned item identification comprises an item type of the item and a reason code for the item being returned;
receiving, at the server, a first communication indicating the item has been received at the store with the smart label affixed to the item;
receiving, at the server, a second communication indicating a physical location of the item within the store;
determining, based on the reason code, to add the item to an inventory system, to yield a determination, the inventory system comprising a store-specific product inventory database and a global product inventory database;
updating the store-specific product inventory database based on the determination, the first communication, and the second communication, the store-specific product inventory database being associated with the store; and
updating the global product inventory database based on the determination, the first communication, and the second communication.

16. The non-transitory computer-readable storage medium of claim 15, having additional instructions stored which, when executed by a computing device, cause the computing device to perform operations comprising:
receiving, at the server, an online request for the item type; and
returning, in response to the online request, an availability of the item type based on an updated global product inventory database.

17. The non-transitory computer-readable storage medium of claim 15, having additional instructions stored which, when executed by a computing device, cause the computing device to perform operations comprising:
receiving, at the server, an online request for the item type;
identifying the item as satisfying the online request; and
issuing a notification for a store associate to fill the online request by retrieving the item from the physical location.

18. The non-transitory computer-readable storage medium of claim 15, having instructions stored which, when executed by a computing device, cause the computing device to perform operations comprising:
receiving, at the server, a request from a store associate in the store for locations of the item type within the store; and
issuing a notification to the store associate, the notification comprising the physical location of the item.

19. The non-transitory computer-readable storage medium of claim 8, wherein the request from the store associate further requests a quantity of the item type within the store; and
wherein the notification to the store associate further comprises the quantity of the item type within the store based on an updated store-specific product inventory database.

20. The non-transitory computer-readable storage medium of claim 15, wherein the global product inventory reflects worldwide inventory of at least the item type.
